(19) United States
(12) Patent Application Publication
(10) Pub. No.: US 2011/0016757 A1
(43) Pub. Date: Jan. 27, 2011

(54) GREETINGS CARD

(76) Inventor: James BECKETT, Edinburgh (GB)

Correspondence Address: SHERIDAN ROSS PC, 1560 BROADWAY, SUITE 1200, DENVER, CO, 80202, US

(21) Appl. No.: 12/841,598

(22) Filed: Jul. 22, 2010

(30) Foreign Application Priority Data
Jul. 24, 2009 (GB) 0912918.0

(51) Int. Cl. G09F 1/00; B26D 1/00

(52) U.S. Cl. 40/124.06; 83/13

(57) ABSTRACT

A customizable greetings card system comprises a plurality of display pieces; and a greetings card comprising a display face arranged to receive a plurality of the display pieces, wherein:—the display face comprises a plurality of receiving locations each for receiving and retaining one of the display pieces; at least some of the display pieces comprise a display surface displaying a respective letter, number or word; and each display piece is for reception and retention in any one of the receiving locations, thereby allowing selected, different combinations of the display pieces to be retained on the display face and thus selected different messages to be displayed.

### FIELD OF THE INVENTION

The present invention relates to a greetings card, for example to a greetings card that may be customized by a user.

### BACKGROUND TO THE INVENTION

Known greetings cards are usually sold with pre-printed and therefore fixed greeting messages or images and the purchaser of the greeting card is therefore restricted with regard to what greeting message they can convey to the intended recipient of the greeting card, other than by writing or drawing on an additional message or image by hand.

### SUMMARY OF THE INVENTION

In a first, independent aspect of the invention there is provided a customizable greetings card system comprising:—a plurality of display pieces; and a greetings card comprising a display face arranged to receive a plurality of the display pieces, wherein:—the display face comprises a plurality of receiving locations each for receiving and retaining one of the display pieces; at least some of the display pieces comprise a display surface displaying a respective letter, number or word; and each display piece is for reception and retention in any one of the receiving locations, thereby allowing selected, different combinations of the display pieces to be retained on the display face and thus selected different messages to be displayed.

Thus a user, for example a purchaser and/or sender of the greetings card, can select a message to be displayed on the greetings card using the display pieces. The user may change the arrangement of the display pieces to create a customized greeting message for the intended recipient of the card.

The process of thinking up a customised greeting message by the sender of the card, as well as the physical act behind re-arranging the display pieces into a greetings message, may be found to be fun, creative and amusing to do. The recipient can receive a personalised greeting message from the sender and will note the extra time, thought and effort behind the giving of the card.

The images, letters and/or words displayed on the display pieces can have numerous different styles and fonts which can help to convey different types of greeting. For example, if it is Halloween, display pieces having a scary font could be used. Display pieces of different styles or fonts may be provided in the same packaging as the card, enabling the user to select the style or font to be used. Alternatively, a manufacturer may select a style or font to be provided. Alternatively, the display pieces and the card may be provided in separate packaging, and the purchaser may be able to select and purchase different combinations of greetings card and display pieces having different styles or font for use with the greetings card.

Due to the customisable nature of the message that can be provided on the card, a single customisable message greeting card could be used for any number of given occasions or purposes.

A greetings card may be any card that may be used to provide a message or an image to a recipient. A greetings card may be a card suitable for marking an occasion or day, for example, a birth, birthday, marriage, engagement, wedding anniversary, Christmas, Easter, Mothers Day, Fathers Day, Valentines Day, Halloween, for expressing a sentiment, for example gratitude, congratulations, commiserations or sympathy, or for providing a greeting or other message to a recipient for any other reason or at any other time, for example when the sender is on holiday

Each display piece may be shaped so that it can be received in any one of the receiving locations.

At least some, or all, of the display pieces may not include any indication of a receiving location in which they are intended to be received and retained. At least some, or all, of the display pieces may not include any indication on their display surface of a receiving location in which they are intended to be received and retained. Such an indication could be in the form of a reference mark, for example a reference letter, word or number, provided on the display piece or in the form of the shaping of the display piece. By providing that the display pieces do not include any indication of a receiving location, it can be made clear that any combination of display pieces can be selected to be displayed.

The number of display pieces may be greater than the number of receiving locations. Thus, the number of possible messages that can be displayed can be increased.

Each receiving location may comprise a cavity in the display face or part of a cavity in the display face. The or each piece may be retained on the display face by insertion into the cavity or part of a cavity that makes up a receiving location.

Each display piece may be shaped to be interlockable with the cavity or one of the cavities or with part of the cavity or one of the cavities.

The or each display piece may be retained on the display face by such interlocking. The display pieces and cavity or cavities may be shaped so that the display pieces just fit in the cavity or cavities making up the receiving locations. The display pieces may be held in place by a compression of the display pieces and/or the cavities. Thus, the display pieces may be held in place in the receiving locations without requiring the use of adhesive.

The greetings card may further comprise a backing portion for closing the or each cavity on a reverse side of the display face. The backing portion may comprise a backing layer.

The display pieces and/or the display surface may be formed, for example of a resilient material. The display pieces and/or the display surface may comprise, for example, cardboard, plastic or metal.

Each receiving location may comprise at least one male connector and/or at least one female connector.

Each cavity or part of a cavity making up a receiving location may comprise at least one male connector and/or at least one female connector.

Each display piece may be shaped to be interlockable with at least one other display piece. The or each display piece may be retainable on the display face by such interlocking. The display pieces and cavity or cavities may be shaped so that the display pieces just fit with other display pieces when in the receiving locations. The display pieces may be held in place by a compression of the display pieces. The display pieces may be held in place in the receiving locations in similar fashion to the way in which jigsaw pieces can be held in place in jigsaws.

Each display piece may comprise at least one male connector and/or at least one female connector.

Each receiving location may comprise attachment means for attaching a display piece. The attachment means may comprise the or a male or female connector. Alternatively or additionally, the attachment means may comprise adhesive, a magnet or hook and eye arrangement. For example, in one arrangement, the display pieces may comprise magnets or magnetisable metal. The receiving locations may also comprise magnets or magnetisable metal. The display pieces may thus be retained in receiving locations by magnetic interaction between the display pieces and the receiving locations.

At least some of the display pieces may be substantially identical in shape to at least some other of the display pieces.

Each of a plurality of the display pieces may be attached to a respective receiving location by a breakable tab.

Each of the display pieces may be substantially identical in shape to each other of the display pieces. Each display piece may be substantially identical in shape to each other display piece or to a combination of at least some of the other display pieces.

At least some of the display pieces may comprise a display surface displaying a respective single letter. The single letters that are displayed on the display pieces may comprise each letter of the alphabet. Thus, any message can be formed and displayed on the card, only limited by the number of receiving locations and display pieces. Furthermore, messages in other languages as well as English can be created.

At least some of the display pieces may have display surfaces that display the same letter, word or number as at least some other of the display pieces.

Each display piece may be configured to be repeatedly receivable by and removable from a receiving location. Thus, the card may be reused, or a user may try out different messages before finalising their message. Alternatively or additionally, the display pieces may be re-used by the recipient of the card to create their own greeting message for their own amusement, or for sending back to the original sender of the card, or for sending on to another person.

The system may further comprise a storage surface for storing the plurality of display pieces, the storage surface being arranged so that any of the display pieces can be removed from the storage surface for reception and retention in a selected one of the receiving locations.

That can provide a particularly convenient way of storing the display pieces, and of displaying to the user the display pieces that are available.

The storage surface may comprise a plurality of storage locations each for receiving and retaining a respective one of the plurality of display pieces, and the number of storage locations of the retention surface may be greater than or equal to the number of display pieces.

The number of storage locations of the storage surface may be greater than the number of receiving locations on said face of the greetings card.

A further face of the greetings card may comprise the storage surface.

Each of a plurality of the display pieces may be attached to a respective storage location by a breakable tab.

The display face may be the front face of the card and the further face may be the rear face of the card.

In a further, independent aspect of the invention there is provided a customizable greetings card comprising a display face arranged to receive a plurality of the display pieces, wherein:—the display face comprises a plurality of receiving locations each for receiving and retaining a respective one of the display pieces; and each receiving location is configured to receive and retain any selected one of the display pieces, thereby allowing selected, different combinations of the display pieces to be retained on the display face and thus selected different messages to be displayed.

In another, independent aspect of the invention there is provided a set of display pieces configured for reception and retention in receiving locations on a display face of a customisable greetings card, wherein at least some of the display pieces comprise a display surface displaying a respective letter, number or word; and each display piece is for reception and retention in any one of the receiving locations, thereby allowing selected, different combinations of the display pieces to be retained on the display face and thus selected different messages to be displayed.

In another independent aspect of the invention there is provided a method of manufacture of a customizable greetings card, comprising cutting outlines of plurality of display pieces in a surface to form a plurality of display pieces and a plurality of locations for the display pieces, wherein the method further comprises cutting only a part of the outline of each display piece to leave at least one tab of material connecting each display piece to each location.

There may also be provided an apparatus or method substantially as described herein with reference to the accompanying drawings.

Any feature in one aspect of the invention may be applied to other aspects of the invention, in any appropriate combination. For example, apparatus features may be applied to method features and vice versa.

### DETAILED DESCRIPTION OF EMBODIMENTS

Embodiments of the invention are now described, by way of non-limiting example, and are illustrated in the following figures, in which:—

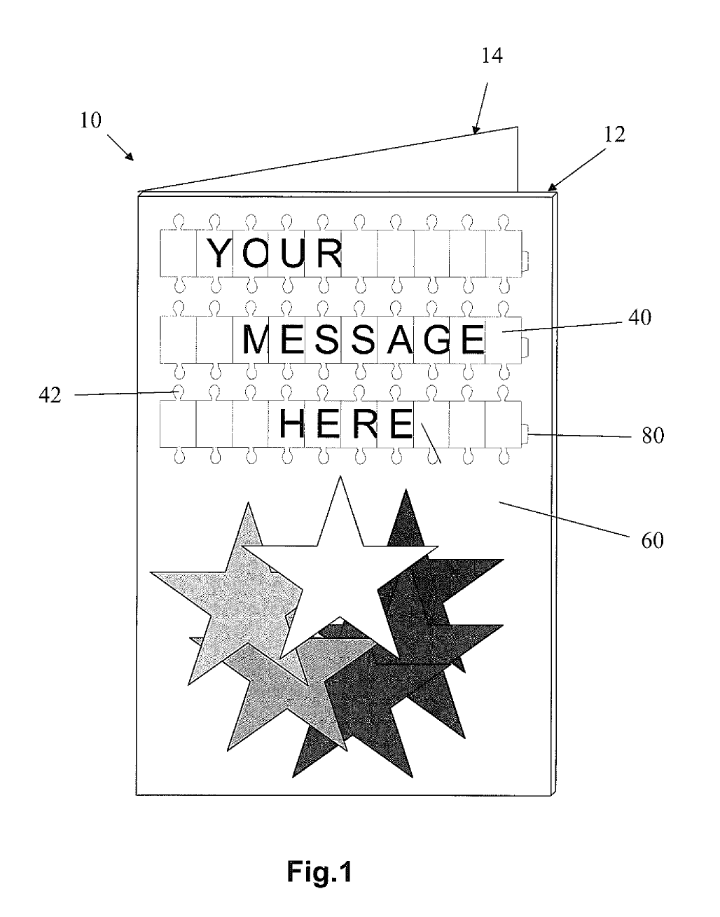

FIG. 1 is an illustration of a partially-opened card in perspective view according to one embodiment, showing a message displayed on the front cover of the card;

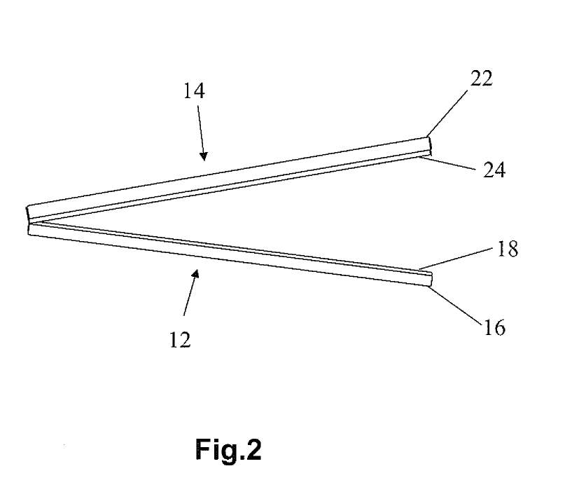

FIG. 2 is an illustration of the card of FIG. 1 in a top-down view;

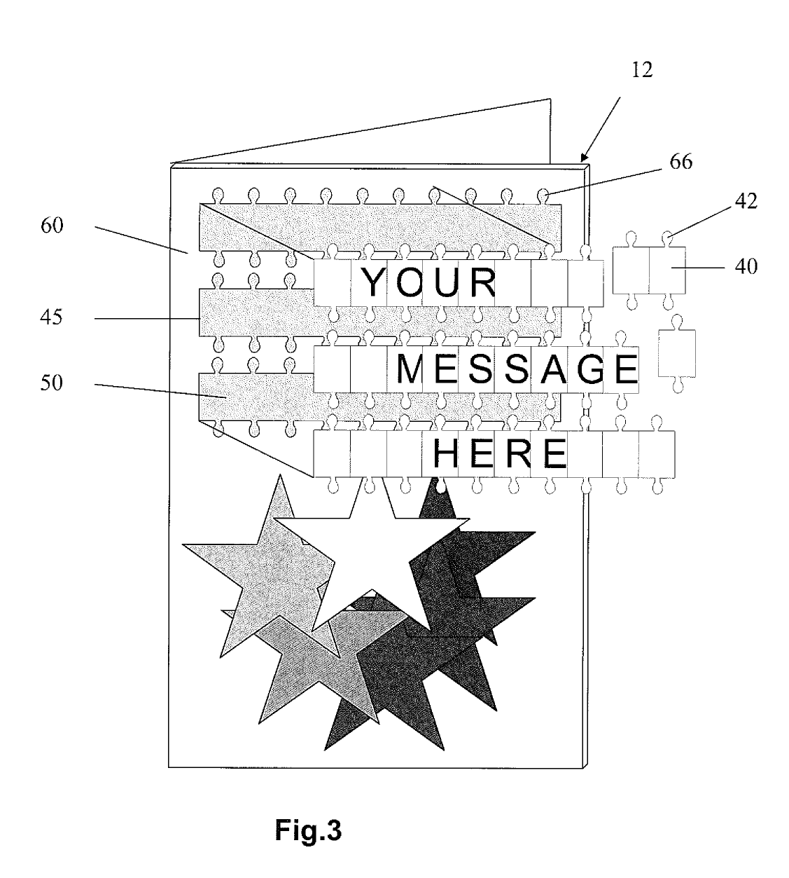

FIG. 3 is an illustration of the card of FIG. 1, in a partially exploded, perspective view showing display pieces that are to be received and retained on the front cover of the card, and the cavities in which the display pieces are to be received;

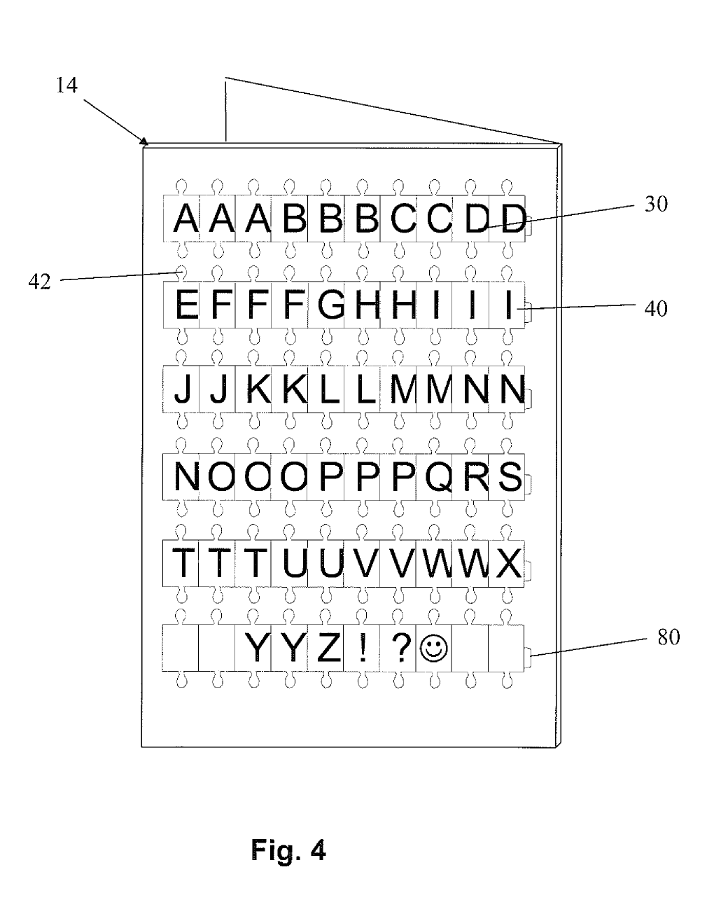

FIG. 4 is an illustration of the card of FIG. 1, showing the back cover of the card;

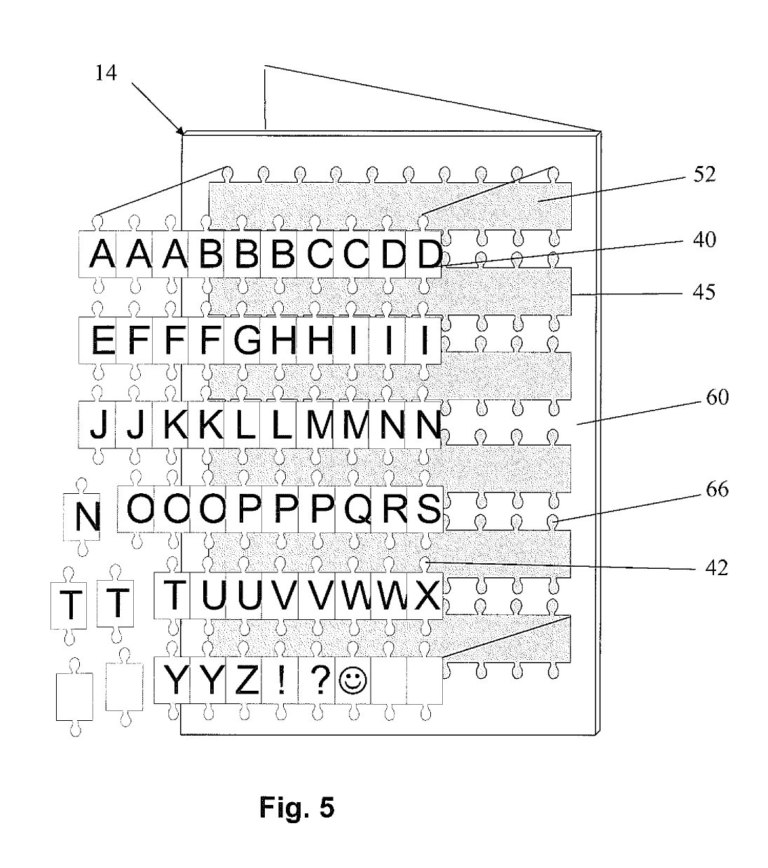

FIG. 5 is an illustration of the card of FIG. 1, in a partially exploded, perspective view showing display pieces that are to be stored on the back cover of the card, and the cavities in which the display pieces are to be stored;

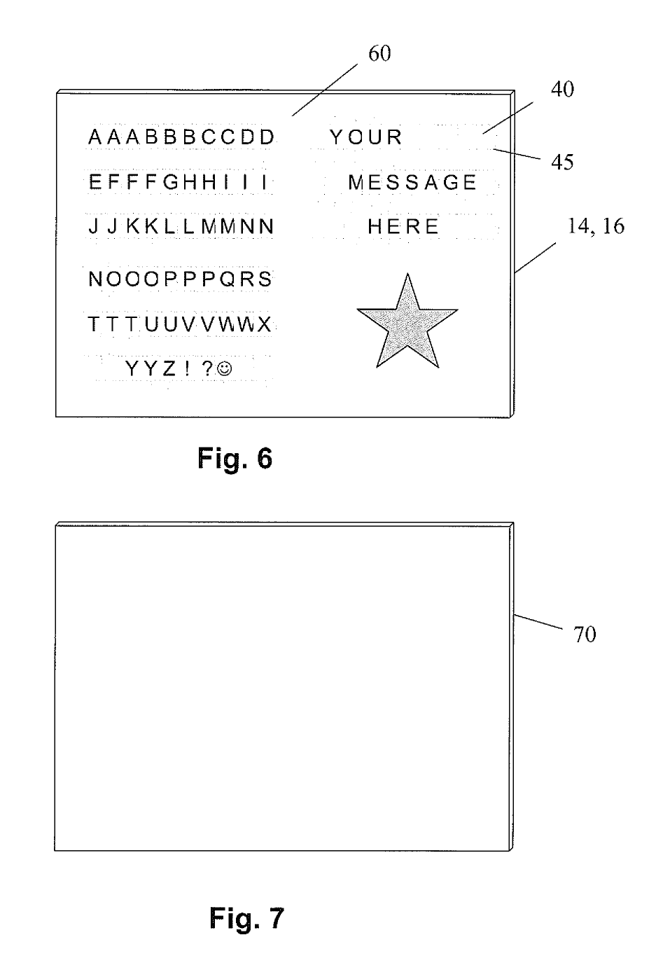

FIG. 6 is an illustration of an outer sheet of the card of FIG. 1 at a stage during the manufacturing process before the outer sheet has been attached to an inner sheet and before the card has been folded;

FIG. 7 is a an illustration of the inner sheet of the card of FIG. 1 at a stage during the manufacturing process before the inner sheet has been attached to the outer sheet and before the card has been folded;

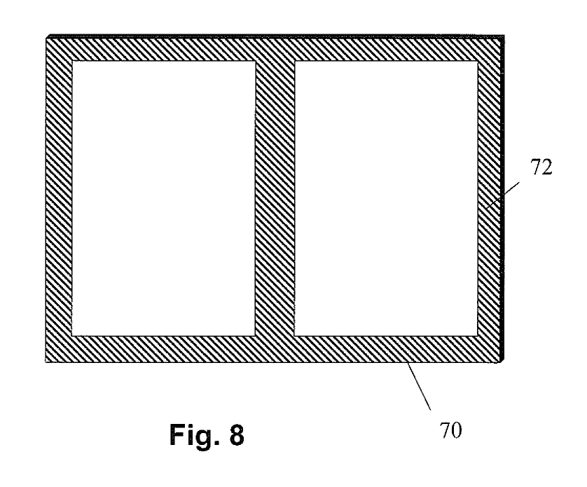

FIG. 8 is a schematic illustration of the inner sheet showing by shading those areas on which adhesive is applied to attach the inner sheet to the outer sheet of FIG. 6;

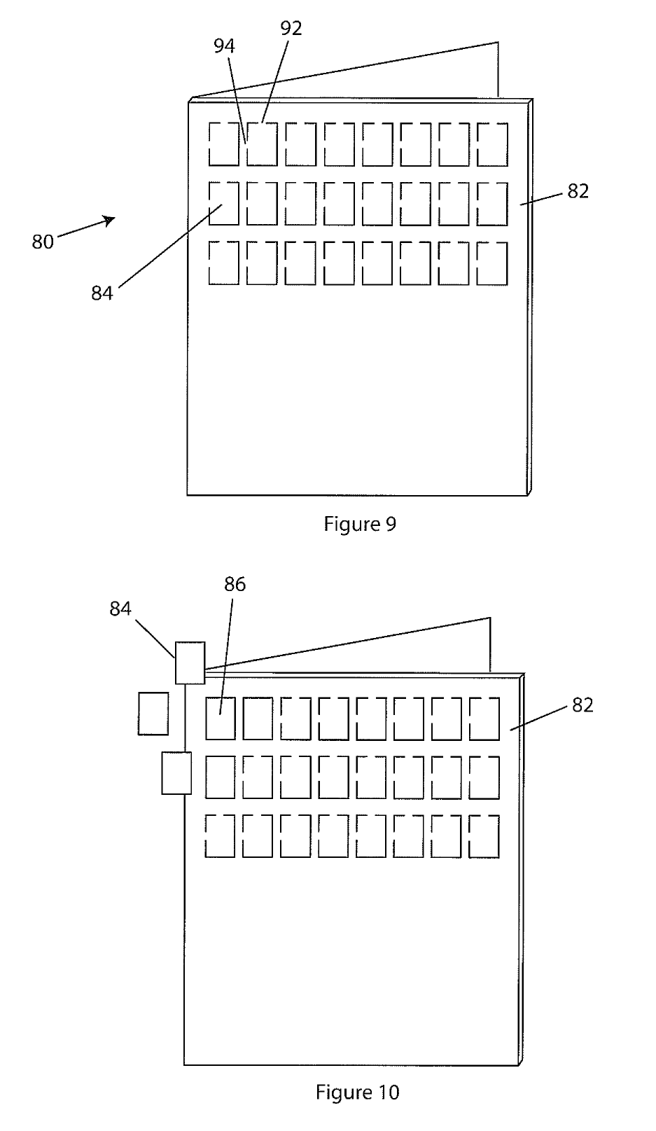

FIGS. 9 to 12 are illustrations of a card according to a further embodiment; and

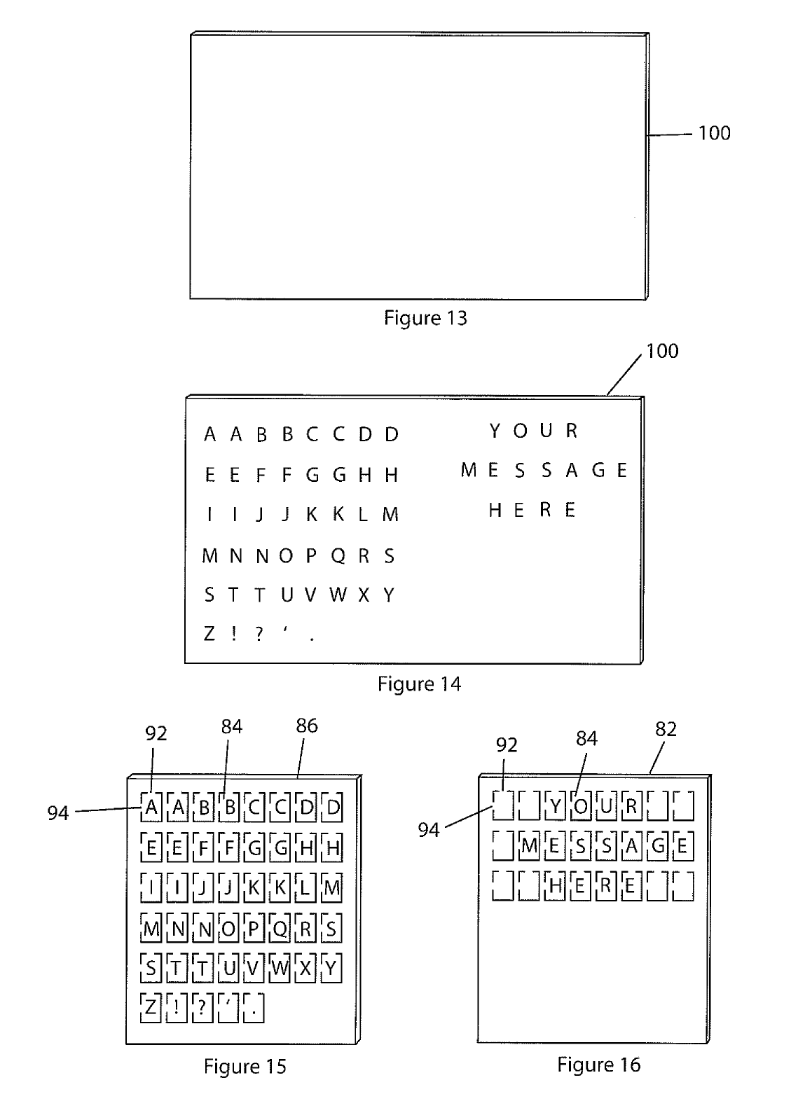

FIGS. 13 to 19 are illustrations of stages in a method of manufacture of the card of FIGS. 9 to 12.

FIG. 1 shows in perspective view a customisable greeting card 10 according to one embodiment. The greetings card is shown in a top-down view in FIG. 2.

The greeting card has a front cover 12 and a back cover 14. As shown in FIG. 2 the front cover 12 is composed of an outer sheet 16 of substantially or at least partially rigid material, such as card, and an inner sheet 18 of substantially or at least partially rigid material glued or otherwise fixed to the outer sheet 16. The back cover 14 is composed of an outer sheet 22 of substantially or at least partially rigid material, such as card, and an inner sheet 24 of substantially or at least partially rigid material glued or otherwise fixed to the outer sheet 22.

According to one method of manufacture, described in more detail below, the inner sheets 18, 24 of the front and back covers 12, 14 are formed from a single, folded piece of cardboard or other substantially or at least partially rigid material. Similarly the outer sheets 16, 22 of the front and back covers 12, 14 are formed from another single, folded piece of cardboard or other substantially or at least partially rigid material.

Referring to FIG. 1, the outer sheet 16 of the front cover 12 includes a plurality of display pieces 40 that are retained on the front cover 12 to form a message. Each display piece 40 includes a plurality of male portions 42 in the embodiment shown in FIG. 1.

FIG. 3 shows the card of FIG. 1 in a partially exploded view. It can be seen from FIG. 3 that each display piece 40 is disposed in a receiving location comprising a cavity 50, formed by a hole or aperture in the outer sheet 16 of the front cover 12, which has a shape defined by an internal perimeter 45 of a border area 60. Three separate cavities 50 are shown in FIG. 3, but any desired number of separate cavities can be provided. The border area 60 has a plurality of female portions 66, which are adapted to mate with the male portions 42 of the display pieces 40 to help prevent the display pieces from falling out of the cavities 50.

No adhesive is required to retain the display pieces 40 in the cavities 50 in the embodiment of FIGS. 1 to 5. Instead, the display pieces are shaped to just fit in the cavities 50 and are held in place by a compression of the material of which they are formed and/or of the material of which the outer sheet 16 is formed when they are received in the cavities. Each display piece 40 and the outer sheet 16 is formed of resilient material and each display piece can be repeatedly received by and removed from a cavity 50 without substantial degradation in the ability of the cavity to hold the display piece 40 in place.

At least some of the display pieces 40 have a letter of the alphabet or image or text printed thereon, and the display pieces 40 can be arranged within the cavity 50 to form a greeting message and/or image as defined by the sender of the customisable message greeting card 10.

Each display piece 40 is the same shape as each other display piece 40 in the embodiment of FIGS. 1 to 5, and therefore any one of the display pieces 40 can be placed in any of the cavities 50 enabling the user to display any message, made up of a combination of display pieces, that they desire. A greater number of display pieces 40 than there are receiving locations on the front cover 12 are usually provided, thus enabling a larger number of possible combinations of display pieces 40 and thus a larger number of possible messages.

Referring to FIG. 1, the border area 60 of the front cover 12 may be provided with one or more semicircular or other cavities 80 disposed between the border area 60 and one or more of the display pieces 40 to facilitate removal of the display pieces 40 from the cavities 50.

FIGS. 4 and 5 show the back cover 14 of the card, and it can be seen that a plurality of the display pieces 40 are stored on the back cover 14. The display pieces 40 are disposed in storage cavities 52, comprising holes or apertures in the outer sheet 16 of the back cover 14, which have a shape defined by an internal perimeter 45 of a border area 60. The border area 60 has a plurality of interlocking female portions 66, which are adapted to mate with the interlocking male portions 42 of the display pieces 40 to help prevent the stored display pieces from falling out of the storage cavities 52.

The display pieces 40 stored on the back cover 14 in the embodiment of FIG. 5 include display pieces each displaying a letter of the alphabet. All of the letters of the alphabet are displayed, individually, on at least one of the display pieces. Thus, any word can be spelled out by the user on the front cover 12 using the display pieces stored on the back cover 14, subject to limitations arising from the number of display pieces displaying each letter and number of receiving locations for those display pieces that are available. More storage locations 52 are provided on the back cover 14 than there are display locations 50 on the front cover 12, in the embodiment of FIGS. 1 to 5. It can be seen from FIG. 5 that more examples of the letters that may be most commonly used in a message (for example the vowels) than letters that may be less commonly used are stored on the back cover 14.

The border area 60 of the back cover 12 may be provided with one or more semicircular or other cavities 80 disposed between the border area 60 and one or more of the display pieces 40 to facilitate removal of the display pieces 40 from the cavities 52.

Referring to FIG. 2, the border area 60 of the outer sheet 16 of the front cover 12 and the outer sheet 22 of the back cover 14 is glued or otherwise fixed to a respective one of the inner sheets. Thus, each of the cavities 50, 52 is backed by one of the inner sheets 18, 24, which helps to prevent the display pieces 40 from falling out of the cavities 50, 52 when the front cover 12 and the back cover 14 of the customisable message greeting card 10 are open or when the greeting card is being handled.

A method of construction of the greeting card of FIGS. 1 to 5 is now described with reference to FIGS. 6 to 8.

Firstly, a piece of substantially or at least partially rigid material, such as card, which will form the outer sheet 16 of the front cover 12 and the outer sheet 16 of the back cover 12, is printed with the puzzle text images. This is then die-cut with a pattern of cuts to form the display pieces 40 and the internal perimeters 45 of the border areas 60.

Another piece of substantially rigid material 70, such as card, which will form the inner sheet 18 of the front cover 12 and the inner sheet 24 of the back cover 14, is glued or otherwise fixed to the outer sheet 16 of the front cover 12 and the outer sheet 22 of the back cover 14 along the area 72 as shaded in FIG. 8.

A fold is then applied between the front cover 12 and the back cover 14.

It is not essential that the back cover is made of an upper and lower sheet, indeed, it could be the case that the extra letters be included with the card in a separate insert.

In the example describe above in relation to FIGS. 1 to 5, each display piece 40 has a letter printed on it. In alternative embodiments, whole words, pictures or parts of images are printed on single display pieces. So, for example, words that might be expected to appear on a greetings card, such as ‘Congratulations’ or ‘Birthday’ are provided on single display pieces in such embodiments. Display pieces may display images or parts of images as well as or instead of letters or words. In some such embodiments, a single display piece displaying a whole word (or an image or part of an image) has the same shape and size as a combination of other display pieces, for example the combination of display pieces displaying single letters that would spell out that word when received and retained in the receiving locations. Thus, the same front cover of the card could be used to receive combinations of display pieces displaying single letters, whole words and/or images.

In the embodiment described in relation to FIG. 5, the back cover of the card is used to store the display pieces that can be used to construct a greeting message. In alternative embodiments, a separate piece of card or other material, instead of or as well as the back cover of the greetings card, is used to store the display pieces. The separate card or other material may be included as an insert within packaging of the greetings card. The back cover may then be like that of a normal greeting card. In some embodiments, display pieces are provided loose in a bag or other container.

In the embodiments described above, each cavity contains a series of several display pieces. In other embodiments a separate cavity is provided for each display piece. The shapes of the display pieces and of the cavities is not limited to those described in relation to FIGS. 1 to 5. For example, the cavities can be shaped to provide male connectors and the display pieces could be shaped to provide female connectors. Alternatively the cavities and/or the display pieces could each provide a combination of both male and female connectors. In some embodiments, the display pieces include both male and female connectors and the male connector of one display piece mates with the female connector of another display piece when both display pieces are received in cavities or other receiving locations. In other embodiments the cavities and the display pieces do not contain either male or female connectors. The cavities may have the same shape, in the plane of the card, as the display pieces or combinations of the display pieces. Each cavity may be substantially completely coverable or fillable by a display piece or a combination of display pieces. Each display piece may have any suitable shape. Each display piece may be, for example the shape of a square, a circle a triangle, a rectangle or any other suitable regular or irregular shape.

A further embodiment is illustrated in FIGS. 9 to 12. FIG. 9 shows the front face 82 of the card 80. A plurality of display pieces 84 are disposed in receiving locations 86 or cavities. FIG. 10 shows the front face of the card with some of the display pieces 84 removed from their receiving locations 86.

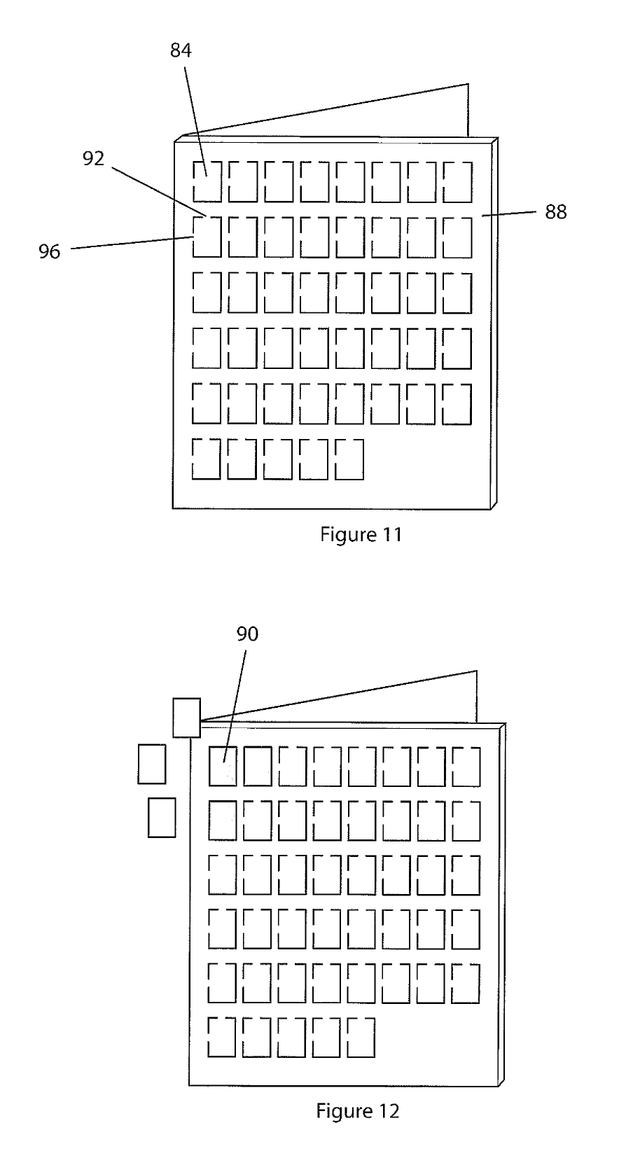

FIG. 11 shows the rear face 88 of the card 80, with display pieces 84 disposed in storage locations 90 or cavities. FIG. 12 shows the rear face 88 of the card with some of the display pieces removed from their receiving locations.

In the embodiment of FIGS. 9 to 12, the display pieces 84 are formed by die cutting the outline of the display pieces from the material of the front or rear face of the card. It is a feature of the embodiment of FIGS. 9 to 12 that the outline of each display piece is not completely cut, instead one or more parts 92, 94 of the rectangular outline of each display piece 84 is left uncut. The uncut parts of the outline are also referred to herein as tabs or notches.

The nature of the die-cut design and subsequent cut, means that after die-cutting the card, each display piece 84 is held within its cavity by one or more tabs or notches. The position of the tabs or notches can be anywhere on the display piece.

On removal of a display piece 84 by the user, the tabs or notches 92, 94 holding the display piece 84 to the cavity border break leaving a trace of card (the remnants of the tab or notch) on both the display piece cavity 86 border and also on the border of the display piece 84 itself. These remnants of card thereafter help wedge and secure the display piece 84 in the cavity 86 if it is reinserted into the cavity 86 or if it is inserted into another cavity. The tabs or notches also help to retain any other display piece that is inserted into the vacated cavity 86. The tabs or notches therefore help to allow for all display pieces to be securely placed into any of the other display pieces cavities by means of a friction and/or or compression effect provided by the presence of the remnants of the tabs or notches.

The text or other images printed on the display pieces are omitted from FIGS. 9 to 12 for clarity

A method of manufacture of the card of the embodiments of FIGS. 9 to 12 is illustrated in FIGS. 13 to 19.

FIG. 13 shows a piece of plain card 100 from which the front and rear faces of the card 80 are formed. FIG. 14 shows the piece of card 100 after printing of images and text for the display pieces onto the piece of card 100. Either the text and images are printed directly onto the piece of card, or the text and images are printed onto a separate piece of paper that is then stuck onto the piece of card 100.

The piece of card is then die-cut, to separate the front 82 and rear 84 faces of the card, and to cut around the display pieces 84. As discussed, the display pieces 84 are not cut around their entire perimeter but instead one or more parts 92, 94 of the perimeter are left uncut.

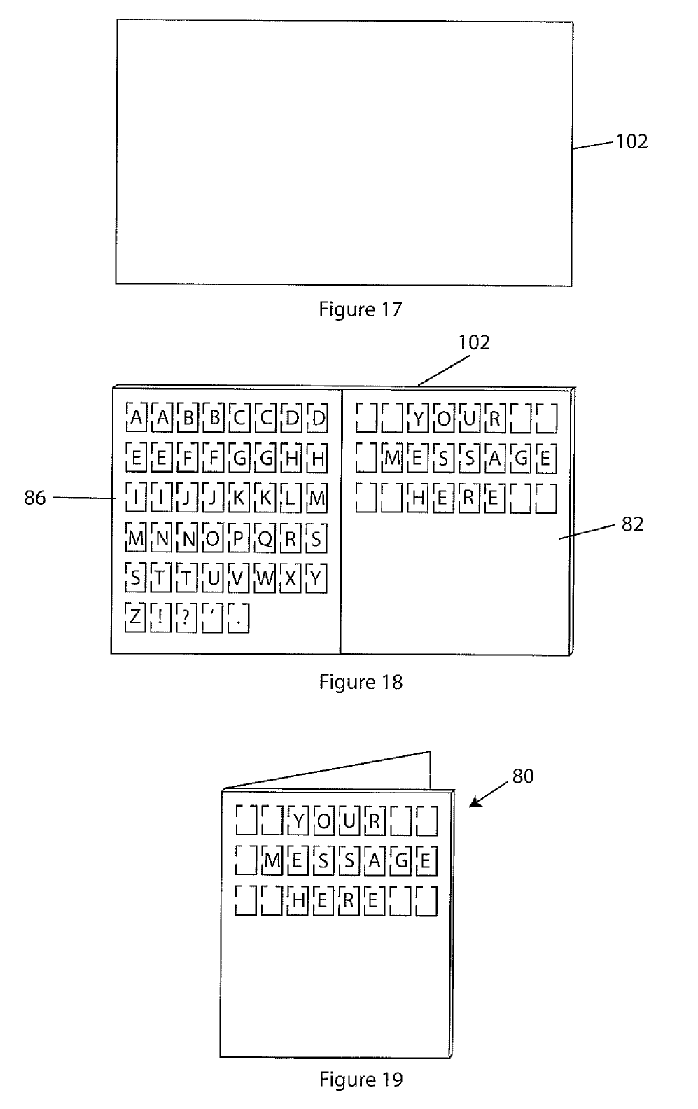

FIG. 17 shows a further plain piece of card 102 that will form the inner part of the card 80. The front 82 and rear faces 84 are then attached (for example, glued) to the inner card 102, as shown in FIG. 18. The inner card 102 is then folded to form the finished card as shown in FIG. 19.

In the embodiments described in relation to FIGS. 1 to 19, the display pieces and the greetings card are formed of card or cardboard. In other embodiments, the display pieces and the greetings card comprise any suitable material or combinations of materials, for example card, paper, metal or plastic. The display pieces and the greetings card can be formed of different materials.

In one embodiment, the display pieces comprise magnets or magnetisable metal. The receiving locations also comprise magnets or magnetisable metal. The display pieces are thus retained in receiving locations by magnetic interaction between the display pieces and the receiving locations, instead of (or as well as) by way of fitting the display pieces into one or more cavities. In another embodiment adhesive, usually reusable adhesive, is used to attach the display pieces to the greetings card. For example, a layer of reusable adhesive can be provided at each of the receiving locations. Any other suitable attachment arrangement can be used to attach the display pieces to the greetings card. For example a hook and eye system can be used, with hooks (or eyes) being provided at the display locations and eyes (or hooks) being provided on the display pieces.

One method of manufacture of the greetings card has been described above in relation to FIGS. 6 to 8, but it will be understood that any suitable method of manufacture may be used.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A customizable greetings card system comprising:—
a plurality of display pieces; and
a greetings card comprising a display face arranged to receive a plurality of the display pieces, wherein:—
the display face comprises a plurality of receiving locations each for receiving and retaining one of the display pieces;
at least some of the display pieces comprise a display surface displaying a respective letter, number or word; and
each display piece is for reception and retention in any one of the receiving locations, thereby allowing selected, different combinations of the display pieces to be retained on the display face and thus selected different messages to be displayed.

2. A system according to claim 1, wherein the number of display pieces is greater than the number of receiving locations.

3. A system according to claim 1, wherein each receiving location comprises a cavity in the display face or part of a cavity in the display face.

4. A system according to claim 1, wherein each display piece is shaped to be interlockable with the cavity or one of the cavities or with part of the cavity or one of the cavities.

5. A system according to claim 3, wherein each cavity or part of a cavity making up a receiving location comprises at least one male connector and/or at least one female connector.

6. A system according to claim 4, wherein each display piece is shaped to fit within the cavity or one of the cavities or with part of the cavity or one of the cavities.

7. A system according to claim 1, wherein at least some of the receiving locations are substantially identical in shape to at least some other of the receiving locations.

8. A system according to claim 1, wherein each display piece is shaped to be interlockable with at least one other display piece.

9. A system according to claim 1, wherein each display piece comprises at least one male connector and/or at least one female connector.

10. A system according to claim 1, wherein each of a plurality of the display pieces is attached to a respective receiving location by a breakable tab.

11. A system according to claim 1, wherein at least some of the display pieces are substantially identical in shape to at least some other of the display pieces.

12. A system according to claim 1, wherein at least some of the display pieces comprise a display surface displaying a respective single letter.

13. A system according to claim 12, wherein the single letters that are displayed on the display pieces comprise each letter of the alphabet.

14. A system according to claim 1, wherein at least some of the display pieces have display surfaces that display the same letter, word or number as at least some other of the display pieces.

15. A system according to claim 1, wherein each display piece is configured to be repeatedly receivable by and removable from a receiving location.

16. A system according to claim 1, wherein the system further comprises a storage surface for storing the plurality of display pieces, the storage surface being arranged so that any of the display pieces can be removed from the storage surface for reception and retention in a selected one of the receiving locations.

17. A system according to claim 15, wherein the storage surface comprises a plurality of storage locations each for receiving and retaining a respective one of the plurality of display pieces, and the number of storage locations of the storage surface is greater than or equal to the number of display pieces.

18. A system according to claim 17, wherein the number of storage locations of the storage surface is greater than the number of receiving locations on said face of the greetings card.

19. A system according to claim 16, wherein a further face of the greetings card comprises the storage surface.

20. A system according to claim 16, wherein each of a plurality of the display pieces is attached to a respective storage location by a breakable tab.

21. A system according to claim 3, wherein the greetings card further comprise a backing layer for closing the or each cavity on a reverse side of the display face.

22. A customizable greetings card comprising a display face arranged to receive a plurality of the display pieces, wherein:—
the display face comprises a plurality of receiving locations each for receiving and retaining a respective one of the display pieces; and
each receiving location is configured to receive and retain any selected one of the display pieces, thereby allowing selected, different combinations of the display pieces to be retained on the display face and thus selected different messages to be displayed.

23. A set of display pieces configured for reception and retention in receiving locations on a display face of a customisable greetings card, wherein
at least some of the display pieces comprise a display surface displaying a respective letter, number or word; and
each display piece is for reception and retention in any one of the receiving locations, thereby allowing selected, different combinations of the display pieces to be retained on the display face and thus selected different messages to be displayed.

24. A method of manufacture of a customizable greetings card, comprising cutting outlines of plurality of display pieces in a surface to form a plurality of display pieces and a plurality of locations for the display pieces, wherein the method further comprises cutting only a part of the outline of each display piece to leave at least one tab of material connecting each display piece to each location.
